(19) United States
(12) Patent Application Publication
(10) Pub. No.: US 2012/0167526 A1
(43) Pub. Date: Jul. 5, 2012

(54) CAPPING APPARATUS AND CAPPING SYSTEM FOR BOTTLE FILLING DEVICE

(76) Inventors: Zheng Shi, Zhejiang (CN); Yonglin Ji, Zhejiang (CN); Zhengfa Wang, Zhejiang (CN); Mingwei Hu, Zhejiang (CN)

(21) Appl. No.: 13/395,285

(22) PCT Filed: Dec. 31, 2009
(86) PCT No.: PCT/CN09/76385

§ 371 Date: Mar. 9, 2012

(30) Foreign Application Priority Data
Sep. 10, 2009 (CN) 200910102266.6

(51) Int. Cl. B67B 3/06

(52) U.S. Cl. 53/287

(57) ABSTRACT

A capping apparatus for a bottle filling device with a capping head main body; a first slide body is located on the capping head main body and can slide up and down; a capping door mechanism is hinged with the capping head main body and the first slide body; a cap sucking head can slide up and down; a middle slide body is arranged between the cap sucking head and the first slide body and can slide up and down; a first spring and a second spring; and a cap inlet chute. A capping system is equipped with a plurality of capping apparatus, the number of the capping apparatus is equal to that of columns of filled bottles, and the cap sucking heads of the capping apparatus are connected together through a connection structure with a mechanism that actuates the cap sucking heads to rise up and fall down.

### FIELD OF IN INVENTION

The present invention relates to a capping apparatus for a linear type bottle filling device.

### BACKGROUND OF THE INVENTION

For the purpose of higher production efficiency of linear type bottle filling device used to fill milk and milk beverages, bottles are normally arranged in a line, where filling, capping and cap tightening are conducted simultaneously. In this case, plastic caps after arrangement are required to be secondarily distributed to their corresponding slideways in an even manner. After being sterilized, the plastic caps are precisely put on bottle openings subject to the predetermined requirements in order to facilitate the following tightening process. Conventionally, bottle caps are branched in the manner that the number of passageways increases geometrically, in other words, one passageway branches into two passageways, two into four, four into eight and the like. The capping is achieved by a power-free cap grabbing, more specifically, the bottle caps sliding off the preset slideways are blocked by two leaf springs at the front end of a grabbing head when the bottle caps are in an inclined state. As the front edge of a bottle cap is lower than the level of the bottle opening while the rear edge is higher than said level, when the bottles horizontally pass through the cap grabbing head, the bottle openings grab the front edges of the bottle caps, which are then carried away and fall on the bottle openings, during which the leaf springs block the following cap.

The aforesaid solution has the disadvantages that: 1. As the cap passageways increase geometrically, this will bring about huge-sized passageways in case of a great number of bottles are in the line; 2. The bottle caps are not blocked when passing through a sterilizing chamber, therefore the bottle caps are arranged all over the cap slideways. It is no problem for sterilization during normal working process but unfavorable for the beginning. When the bottle caps pass though the cap slideways rapidly due to less bottle caps distributed therein, consequently, the sterilizing is incomplete, the hygienic quality of the final products will be affected; 3. When grabbing is used for capping, if the bottle caps fail to precisely fit with the bottle openings, the bottle caps would not be covered properly. It will affect the following tightening effects. Furthermore, the grabbing head is disposed with the leaf springs for plastic caps, it is sometimes unreliable that the following cap may be carried over together with the previous one.

### SUMMARY OF THE INVENTION

In view of the abovementioned problems, it is one object of the invention to overcome the drawbacks of the prior art by providing a reliable capping apparatus for a bottle filling device. To achieve the aforesaid object, the adopted technical solution is described below: a reliable capping apparatus for a bottle filling device, in accordance with the present invention, comprises a capping head main body, a first slide body which is slidable up and down the capping head main body, and a capping door mechanism, which is hinged with the capping head main body and the first slide body.

Said capping apparatus also includes a cap sucking head, which is slidable up and down and which is connected to a mechanism driving the cap sucking head to move up and down. The cap sucking head can move downwards to apply bottle caps onto containers via the capping head main body.

Between the cap sucking head and the first slide body is disposed with a middle slide body capable of sliding up and down, the middle slide body moves downwards to act on the first slide body to drive it to move downwards. A spare distance is disposed at the upper and lower directions of the middle slide body and the first slide body, so that the middle slide body will not act on the first slide body while moving downwards at the initial stage.

The capping apparatus is also disposed with a second spring and a first spring, in which the second spring is compressed to act on the middle slide body along with the downward movement with the cap sucking head. The first spring is located between the capping head main body and the first slide body and supports the first slide body.

The capping apparatus is also provided with cap inlet chutes.

It is another object of the invention to provide a reliable capping system which is applied for the bottle filling device. To achieve this object, the adopted technical solution is described below: a capping system, in accordance with the present invention, comprises a plurality of capping apparatus whose number equals to the lines of bottle, wherein the capping apparatus are the ones described above, the cap sucking heads of the capping apparatus are connected together via a connecting structure and then connected to the mechanism which drives said cap sucking heads to move up and down.

When the technical solutions provided herein are adopted, the capping motion can be stably, reliably and precisely achieved, thus the working quality of the linear type bottle filling device is improved.

### BRIEF DESCRIPTION OF THE DRAWINGS

FIG. 1 is a schematic diagram of a capping apparatus for a bottle filling device with cap sucking heads rising at the top point in accordance with an example of the present invention;

FIG. 2 is a sectional view of the capping apparatus for the bottle filling device in accordance with the example of FIG. 1 taken from the line A-A;

FIG. 3 is a schematic diagram of a capping system assembled from the capping apparatus in accordance with the example of FIG. 1 of the present invention; and

FIG. 4 is a left view of the capping system in accordance with the example of FIG. 3 of the present invention.

### DETAILED DESCRIPTION OF THE EMBODIMENTS

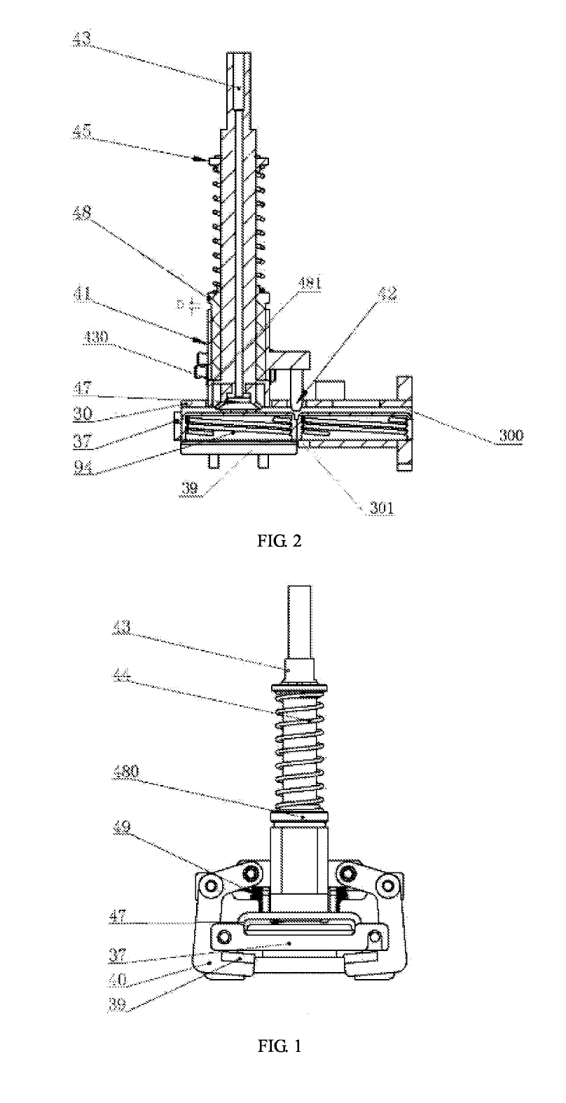

As shown in FIGS. 1 and 2, a capping apparatus for bottle filling device, in accordance with the present invention, comprises a capping head main body 30, a first slide body 41 which is slidable up and down the capping head main body 30, and a swingable capping door mechanism, which is composed of a connecting rod 40 and a door structure 39. The door structure 39 is a cap pallet for a capping orifice 301 on the capping head main body. After the door structure is closed, a cap 94 to be covered slides onto the cap pallet. The connecting rod 40 is hinged with the capping head main body 30 and the first slide body 41.

The capping apparatus is also disposed with a cap sucking head 43 which is slidable up and down. The head of the cap sucking head is a vacuum sucking disc 47 and the middle of the cap sucking head is disposed with air passages. The cap sucking head is connected with a mechanism which drives it to move up and down. When the cap sucking head moves downwards, it puts the cap 94 on a container via the capping head main body.

Between the cap sucking head and the first slide body is disposed with a middle slide body 48, which can move downwards to act on the first slide body to drive it to move downwards. A spare distance D is disposed at the upper and lower directions of the middle slide body and the first slide body, so that the middle slide body will not act on the first slide body while moving downwards at the initial stage.

The first slide body is a slide seat disposed from top and bottom, the middle slide body is disposed in the slide seat and the middle slide body is a slide sleeve that is disposed from top to bottom, and the cap sucking head is disposed in the slide sleeve.

Between the cap sucking head and the middle slide body is disposed with a second compression spring 44, which is located between a supporting ring 45 fixed at the rear of the cap sucking head and a raised edge 480 of the middle slide body. The second spring is compressed to act on the middle slide body along with the downward movement of the cap sucking head. A first compression spring 49 is disposed between the first slide body and the capping head main body and supports the first slide body.

Said capping apparatus is disposed with cap inlet chutes 300 and one section of said cap inlet chute is disposed within said capping head main body.

The spare distance D equals to a movement distance that the cap sucking head travels to suck up caps. Therefore, when the cap sucking head driven by the driving mechanism moves downwards to suck up the caps, the middle slide body can act on the first slide body to drive it to move downwards to open the door structure 39. In this way, the cap sucking head continuously moves downwards to carry out the capping process, thus the capping is in a highly efficient mariner.

The cap sucking head has a structure that can raise the middle slide body and the first slide body when the cap sucking head moves upwards. In accordance with this example, said structure is a step surface 430. The middle slide body has a lower end portion 481 which is raised by said structure earlier than the first slide body. When the raised edge 480 acts on the upper end of the first slide body, the first slide body begins to move downwards, then the capping door mechanism gradually opens up along with the downward movement of the first slide body until the first slide body is blocked by a stopper on the capping head main body. At this point, the door structure 39 opens to the maximum degree and the cap sucking head keeps moving downwards, but the first slide body and the middle slide body stop going down. When the head of the cap sucking head descends via the capping orifice 301 on the capping head main body until the cap 94 is put on the bottle opening, the vacuum sucking disc releases the cap and the cap sucking head driven by the driving mechanism rises back to its original position. The step surface 430 firstly contacts with the lower end portion 481 to drive the middle slide body to rise. After the cap sucking head rises by another distance equivalent to the spare distance D, the step surface contacts with the first slide body and drives both the first slide body and the middle slide body to rise back to their original positions.

To facilitate orderly capping operations, said first slide body is connected with a cap inlet door 42 which functions to block the cap inlet chutes. The closing position of the cap inlet door is not located at the central portion of the cap inlet chute 300. Therefore, the cap inlet door can be closed by means of a clearance at the non-central portion formed between two adjacent caps, so that the cap inlet door 42 is closed without being affected by the caps. The capping head main body is connected with a cap slideway 104 that is disposed from top to bottom.

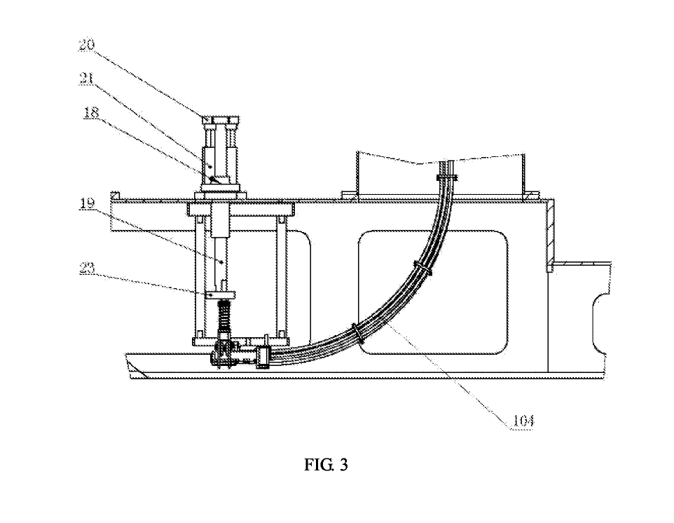

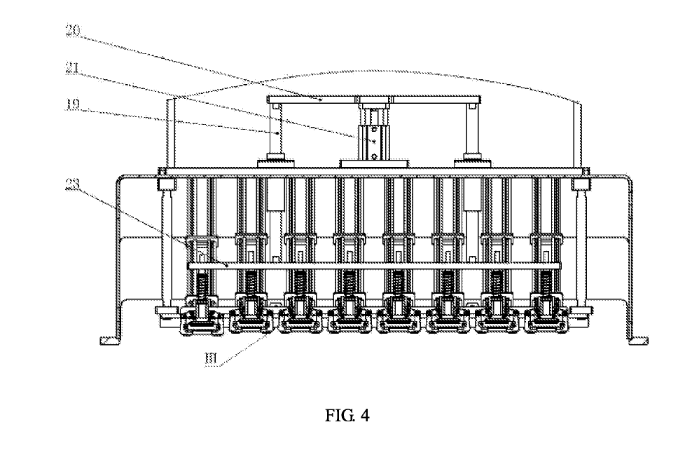

As shown in FIGS. 3-4, the capping head main body has an open-mouthed front end that is disposed with a movable door 37. Workers can take out the caps within the capping head main body during overhaul. When applied in the bottle filling device, capping apparatus III are arranged in rows and have a number equivalent to that of filled bottle lines. The cap sucking heads of said capping apparatus are connected together via a connecting plate 23 and then connected with a vertical guide rod 19, a cylinder connecting plate 20, and finally a cylinder 21, which drives the cap sucking heads to move up and down.

The cap slideways 104 and the capping apparatus III are located within a sterilized chamber IV. The cap slideways 104 face the cap slideways in a sterilizing chamber one by one. The cap slideways in the sterilizing chamber are also cap slideways from top to bottom, having the same number as the capping apparatus III. The upper end of the cap slideways in the sterilizing chamber are connected with cap distribution devices, which divide the caps from cap arrangement devices into multiple lines whose number equals to that of the cap slideways in the sterilizing chamber, and then the caps are fed into the sterilizing chamber.

1. A capping apparatus for a bottle filling device, characterized in that it comprises a capping head main body, a first slide body which is slidable up and down the capping head main body, and a capping door mechanism which is hinged with the capping head main body and the first slide body;
said capping apparatus also includes a cap sucking head, which slidable up and down and which is connected to a mechanism driving the cap sucking head to move up and down, the cap sucking head can move downwards to apply bottle caps onto containers via the capping head main body;
between the cap sucking head and the first slide body is disposed with a middle slide body capable of sliding up and down, the middle slide body moves downwards to act on the first slide body to drive it to move downwards, a spare distance is disposed at the upper and lower directions of the middle slide body and the first slide body, so that the middle slide body will not act on the first slide body while moving downwards at the initial stage;
the capping apparatus is also disposed with a second spring and a first spring, in which the second spring is compressed to act on the middle slide body along with the downward movement with the cap sucking head, and meanwhile the first spring is located between the capping head main body and the first slide body and supports the first slide body; and
the capping apparatus is also provided with cap inlet chutes.

2. The capping apparatus for bottle filling device according to claim 1, wherein a section of a cap inlet chute is disposed within said capping head main body.

3. The capping apparatus for bottle filling device according to claim 1, wherein the capping head main body is connected with a cap slideway from top to bottom.

4. The capping apparatus for bottle filling device according to claim 1, wherein the spare distance equals to a movement distance where the cap sucking head travels downwards to suck up caps.

5. The capping apparatus for bottle filling device according to claim 1, wherein the first slide body is a slide seat disposed from top to bottom, the middle slide body is disposed in the slide seat and is a slide sleeve disposed from top to bottom, and the cap sucking head is disposed in the slide sleeve.

6. The capping apparatus for bottle filling device according to claim 1, wherein the cap sucking head has a structure that can raise the middle slide body and the first slide body when the cap sucking head moves upwards, the middle slide body has a lower end portion which is raised by said structure earlier than the first slide body.

7. The capping apparatus for bottle filling device according to claim 1, wherein said first slide body is connected with a cap inlet door which functions to block the cap inlet chutes, and the closing position of the cap inlet door is not located at the central portion of the cap inlet chute.

8. The capping apparatus for bottle filling device according to claim 1, wherein said capping head main body is disposed with a capping orifice, and the door structure of said capping door mechanism is a cap pallet.

9. The capping apparatus for bottle filling device according to claim 1, wherein the capping head main body has an open-mouthed front end that is disposed with a movable door.

10. A capping system for bottle filling device, wherein it comprises a plurality of capping apparatus whose number equals to the number of the rows of bottles, the capping apparatus are the ones described in claim 1, the cap sucking heads of the capping apparatus are connected together via a connecting structure and then connected to the mechanism which drives said cap sucking heads to move up and down.

11. The capping apparatus for bottle filling device according to claim 2, wherein the capping head main body is connected with a cap slideway from top to bottom.

12. The capping apparatus for bottle filling device according to claim 5, wherein the cap sucking head has a structure that can raise the middle slide body and the first slide body when the cap sucking head moves upwards, the middle slide body has a lower end portion which is raised by said structure earlier than the first slide body.

13. The capping apparatus for bottle filling device according to claim 5, wherein said first slide body is connected with a cap inlet door which functions to block the cap inlet chutes, and the closing position of the cap inlet door is not located at the central portion of the cap inlet chute.

14. The capping apparatus for bottle filling device according to claim 5, wherein said capping head main body is disposed with a capping orifice, and the door structure of said capping door mechanism is a cap pallet.

15. The capping apparatus for bottle filling device according to claim 5, wherein the capping head main body has an open-mouthed front end that is disposed with a movable door.
